(19) United States
(12) Patent Application Publication
(10) Pub. No.: US 2008/0125679 A1
(43) Pub. Date: May 29, 2008

(54) MULTI-MODE VIBRATING PLATFORM FOR TREATMENT OF THE BODY

(76) Inventor: Bertram Ezenwa, Mequon, WI (US)

Correspondence Address: WISCONSIN ALUMNI RESEARCH FOUNDATION, C/O BOYLE FREDRICKSON S.C, 840 North Plankinton Avenue, Milwaukee, WI, 53203, US

(21) Appl. No.: 11/947,387

(22) Filed: Nov. 29, 2007

Related U.S. Application Data
(60) Provisional application No. 60/867,719, filed on Nov. 29, 2006.

(51) Int. Cl. A61H 1/00

(52) U.S. Cl. 601/49

(57) ABSTRACT

A vibrating footplate provides operates at two or more distinct vibration modes to provide improved stimulation to bone and muscle of a human body having multiple modes of resonance.

### CROSS-REFERENCE TO RELATED APPLICATIONS

This application claims the benefit of U.S. provisional application 60/867,719 filed Nov. 29, 2006 hereby incorporated by reference.

### STATEMENT REGARDING FEDERALLY SPONSORED RESEARCH OR DEVELOPMENT

Not applicable

### BACKGROUND OF THE INVENTION

The present invention relates to mechanical devices for applying beneficial stress to the body for prevention of osteoporosis or stimulation of muscle and tissue.

Bones in the human body are subject to constant remodeling in response to stresses that promote bone formation. Such stresses may occur during natural physical activity or exercise.

One possible treatment for osteoporosis or bone loss may be machines which apply stress to a patient, for example, by means of the patient standing on a vibrating platform that simulates the stresses that would occur through natural activities. Such machines may be useful for those who are unable otherwise to obtain sufficient physical activity or as a method of supplementing physical activity in a more concentrated manner.

An early device, described in U.S. Pat. No. 5,046,484 issued to C. Andrew L. Basset provides a platform that is periodically raised by means of the action of a cam and then dropped abruptly to simulate the natural footfall of an individual. In this case, the stress is caused by rapid deceleration of the platform at the bottom of its travel. The impact rate may be determined by measuring a natural rate of heel strikes when a patient is walking and is determined by the regular rotational speed of the motor.

U.S. Pat. No. 6,659,918 issued to Hans Schiessl uses a crank arm to impart a simple harmonic motion to a similar platform at a frequency dictated by the rotational speed of a motor.

U.S. Pat. No. 5,273,028 issued to Kenneth J. McLeod describe an alternative drive mechanism in which the platform is mounted on springs and driven at a resonant frequency by an electromagnetic actuator or rotating eccentric mass. Such systems provide a single excitation frequency to the platform whose ultimate movement is determined by the resonance of the system including the spring constant of the springs and the mass of the patient.

### SUMMARY OF THE INVENTION

The present inventor has recognized that the body is a complex system of resonant structures having linear and nonlinear elements. For example, lower lumbar vertebrae and hip joints are parts of different resonant structures and thus have different resonant responses. For this reason, inducing desirable levels of stress or muscle activity in different structures may require excitation simultaneously at two or more frequencies at different controlled amplitudes. Current systems which provide a single frequency of excitation, or in the case of an impact system, a single band of frequencies whose amplitudes are essentially uncontrollable, may provide less than optimal excitation of body structures.

Specifically then, the present invention provides an apparatus for mechanical stimulation of the body, including a footplate for receiving feet of a standing person and a actuator attached to the footplate to impart a pattern of vertical motion to the footplate consisting of periodic accelerations at predetermined different times with predetermined different amplitudes.

It is therefore one is an object of the invention to apply substantial energy at multiple different frequencies of vibration to a person as determined by the actuator.

The accelerations may be in a frequency range from 10-100 hertz.

Thus, it is an object of the invention to provide a system that may provide frequencies thought to be desirable for the stimulation of bone strength.

The apparatus may include an adjustment means for changing the time between the periodic accelerations and thus a frequency range of the accelerations.

It is thus an object of the invention to provide a system that allows adjustment of the stimulation frequency.

The actuator may produce a predetermined displacement of the footplate independent of the weight of a body.

It is thus an object of the invention to provide a system that may work with a variety of different patients without adjustment of springs or weights.

The periodic accelerations may be selected to accommodate different resonant modes of different structures of the body.

It is thus an object of the invention to provide a system that recognizes that the body is composed of loosely coupled different resonant structures.

The actuator may include at least one cam having a non-circular profile.

It is thus an object of the invention to provide a flexible, yet simple method of providing an arbitrary multi-frequency excitation pattern to the footplate.

The invention may include cam followers attached to the footplate and resting against multiple synchronously rotated and phased cams.

It is thus an object of the invention to provide a system that minimizes the mass and structure on the moving footplate.

The cam followers may be compliant to control the acceleration of the footplate.

It is thus an object of the invention to reduce high frequency components to the patient, such as may provide for less therapeutic benefit.

The invention may provide a speed-controllable motor for adjustment of the time between the periodic accelerations.

Thus, it is an object of the invention to provide an absolute frequency control independent of the particular patient.

These particular objects and advantages may apply to only some embodiments falling within the claims and thus do not define the scope of the invention.

### BRIEF DESCRIPTION OF THE DRAWINGS

FIG. 1 is a simplified perspective view of the present invention showing a patient standing on a moveable footplate, the patient steadied by optional guide rails;

FIG. 2 is a block diagram of the principal components of the present invention including a controller for controlling a motor drive that is connected to a motor rotating a set of cams driving the footplate of FIG. 1;

FIG. 3 is a side elevational view of the platform of FIG. 1, showing positioning of the cams on either side of the drive motor and their interaction with resilient cam followers attached to the footplate;

FIG. 4 is a pair of aligned graphs showing motion of the footplate and frequency components of the motion of the footplate, the latter illustrating two frequency modes each with controllable amplitude defined by lobes on the cam;

FIG. 5 is an exaggerated profile of the cams of the present invention showing multiple lobes of different height to provide for controlled amplitudes of different stimulation frequencies; and

FIG. 6 is a figure similar to that of FIG. 1 showing a patient on a seated version of the apparatus having a movable footplate and seat pan.

### DETAILED DESCRIPTION OF THE PREFERRED EMBODIMENT

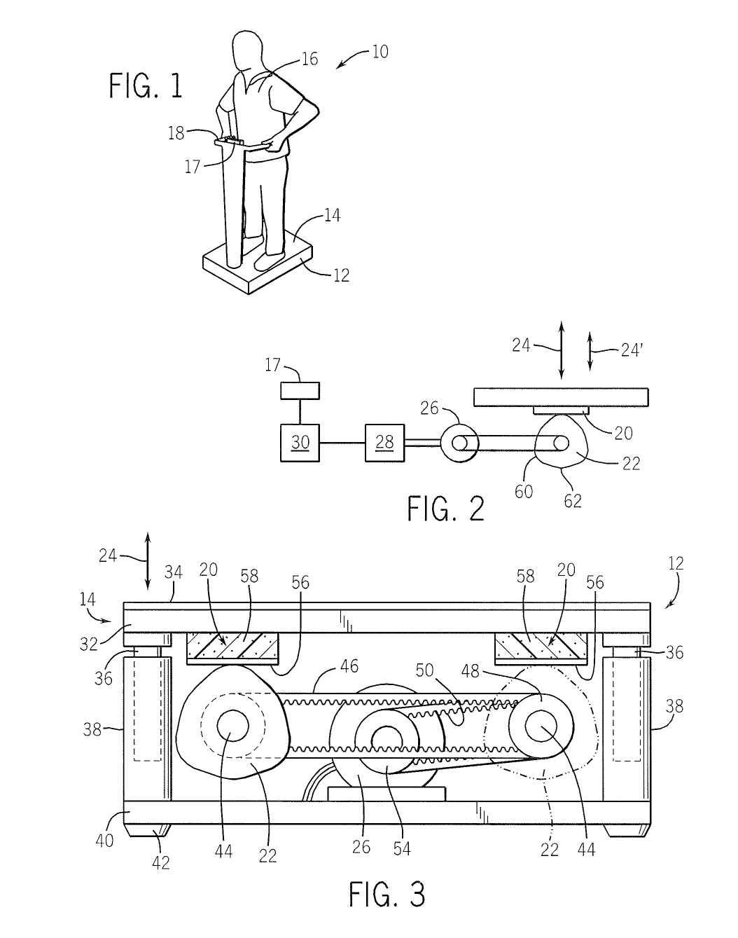

Referring now to FIG. 1, a first embodiment of a bone stimulation system 10 of the present invention includes a floor unit 12 having an upper footplate 14 which may receive the feet of a standing person 16. Rearwardly extending handlebars 18 attached to a post extending upward from the floor unit 12 may be grasped by the person 16 during use of the bone stimulation system 10. A control panel 17 providing for an on an off switch and timer unit may be attached to the handlebars 18

Referring to FIG. 2, the footplate 14 may have on its lower surface cam followers 20 resting against the upper surfaces of different multiple lobe cams 22 (only one shown for clarity) so that the footplate 14 moves along a vertical axis as the cams 22 rotates to follow the displacement dictated by the profiles of the cams 22. The cams 22 may have multiple lobes 60, 62 of different heights so as to impart periodic accelerations 24 and 24′ respectively at different times having different amplitudes. Cams 22 may be rotated by a speed controllable motor 26 driven by a motor controller 28 so that the speed of rotation of the cams 22 may be controlled. A computer 30 may be connected to the motor controller 28 to control a particular stimulation regime with respect to on time and off time and frequencies of rotation of the cam 22 per instructions received from the control panel 17.

Referring now to FIG. 3, the footplate 14 may include a support plate 32 being substantially rigid and, supporting on its upper surface, a traction material 34 providing a no-slip surface for receiving the feet of the person 16. The rigid plate 32 may have downwardly extending shafts 36 at each of its four corners received by the bores of upwardly extending sleeves 38 attached to a base plate 40. The upwardly extending sleeves 38 engage slidingly with the downwardly extending shafts 36 to guide motion of the footplate 14 along the vertical axis of the accelerations 24 and 24′. The base plate 40 that may rest against the floor, for example, on shock absorbing feet 42.

A set of four cams 22 rotating about horizontal axes may be positioned near each of the four corners of the plate 32, beneath the plate 32. Shafts 44 of the cams are mounted for free rotation on bearings and pillow blocks (not shown). The shafts 44 have timing belt pulleys 48 interconnected by a timing belt 46 fitting about timing belt pulleys 48 on each of the shafts 44 so that the cams 22 turn in unison and in the same phase, meaning that the relative position of each cam 22 is the same at all times.

A separate timing pulley 48 on one shaft 44, not visible in FIG. 3, and timing belt 50 connects that shaft 44 to a corresponding timing pulley 54 on the motor 26. The motor 26 may be connected to the variable speed motor controller 28 held within the floor unit 12 and a computer 30 (previously shown in FIG. 2).

At all times during operation, the height of the footplate 14 is determined by the abutment of the outer periphery of the cams 22 with cam followers 20 positioned at the lower surface of plate 32 and resting on each of the cams 22. The cam followers may include a lower wear surface 56 reducing the friction between the cams 22 and the cam followers 20 when the cams 22 are rotating. Above the wear surface 56, the cam followers 20 may be composed on an elastomeric foam 58 serving as a spring element between the plate 32 and the cams 22 providing some attenuation of the peak forces applied to the footplate 14 and high frequency vibration as may be desired.

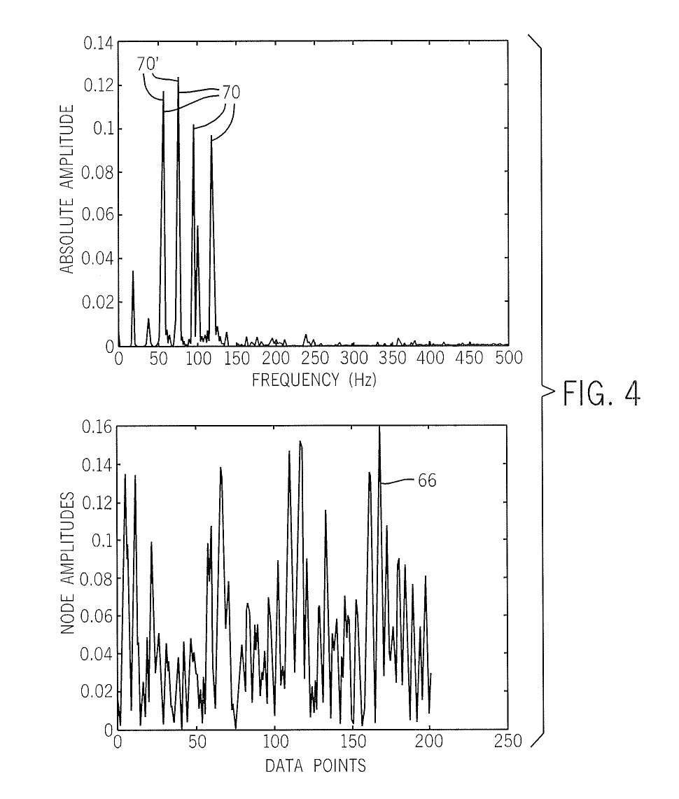

Referring now to FIGS. 4 and 5, each cam 22 may have three primary lobes 60, in this case positioned at 120° spacing around the cam 22 and three secondary lobes 62 also spaced at 120° in between each of the primary lobes 60. The primary lobes 60 and secondary lobes 62 and having a different radii with respect to a center 64 of the cam 22 controlling the relative excursions of the footplate 14 as each lobe 60 and 62 rides against the cam followers 20.

Referring to FIG. 4, a y-axis motion of the footplate 14 along the axis of accelerations 24 and 24′ as a function of time shows complex time domain excursion 66 that are not sinusoidal (that is not composed primarily of a single sinusoid or single frequency in steady-state or in a resonant decay) associated with the complex shape of the cam 22. This complex time domain excursion 66 creates multiple distinct frequency modes 70 at different frequencies. The two most dominant frequency modes 70′, attributable to the lobes 60 and 62, have substantial energy and energy's that match each other to within 20 percent. Notably the frequency of the higher frequency dominant mode 70′ may be less than twice the frequency of the lower frequency dominant mode 70′ providing closer frequency spacing then can be obtained in a standard harmonic typical with the prior art. Additional frequencies modes 70 may be obtained by the impact like interaction between the cam 22 and the cam follower 20. Generally the absolute frequency of the modes 70′ can be adjusted up and down by changing by the rotational speed of the cams 22. Proper design of the profile of the cams 22 allows the energy and frequency of each mode 70 to be tailored as desired and/or additional modes to be generated.

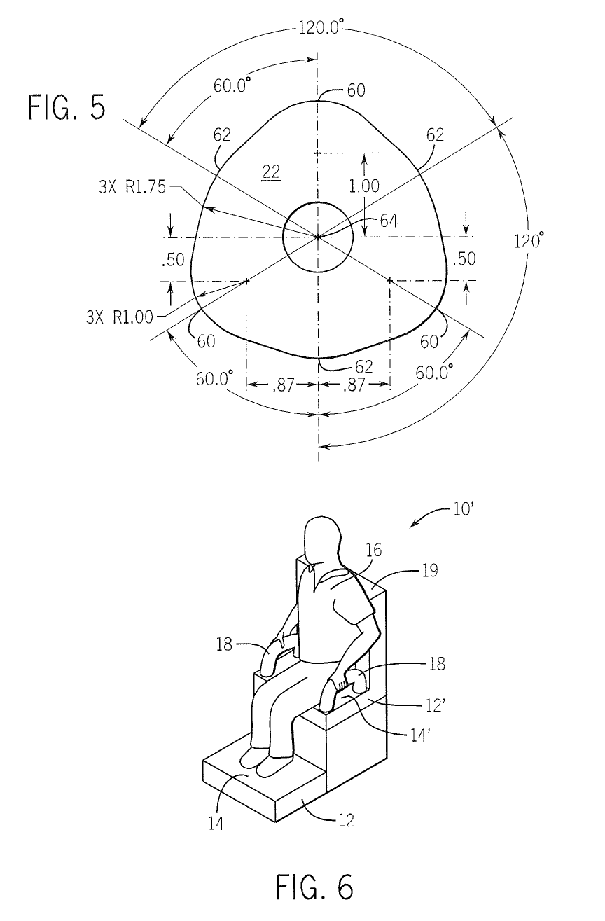

Referring now to FIG. 6, in an alternative embodiment the person 16 may sit on a first seat unit 12′ having a seat pan 14′ constructed according to the floor unit 12 described above. The seat pan 14′ may be elevated sufficiently so that the person's feet may rest on the footplate 14 of the floor unit 12. In this case, handlebars 18 may be positioned on the side of the seat pan 14′ to support the person 16 in a seated posture aided by of seat back 19. Simultaneous vibration of floor unit 12 and seat unit 12′ may provide for a therapeutic action for individuals who cannot stand during treatment. Alternatively, vibration of the seat unit 12′ alone may be provided using the above described multifrequency mechanism, for example, in situations where the floor unit 12 is not warranted, for example for a patient being rehabilitated after hip surgery or who otherwise cannot accept force on their legs, or in situations where a floor unit 12 can not physically be accommodated, for example, in the cockpit of an aircraft.

It is specifically intended that the present invention not be limited to the embodiments and illustrations contained herein, but include modified forms of those embodiments including portions of the embodiments and combinations of elements of different embodiments as come within the scope of the following claims.

What I claim is:

1. An apparatus for mechanical stimulation of the body comprising:
a platform for supporting a body of a seated or standing person; and
an actuator attached to the platform to impart a pattern of vertical motion to the platform consisting of periodic accelerations at predetermined different times with predetermined different amplitudes.

2. The apparatus of claim 1 wherein the accelerations are in a frequency range between 10 and 100 Hz.

3. The apparatus of claim 1 further including an adjustment means for changing the time between the periodic accelerations and thus a frequency range of the accelerations.

4. The apparatus of claim 1 wherein the actuator produces a predetermined displacement of the platform substantially independent of a weight of the body.

5. The apparatus of claim 1 wherein the periodic accelerations are selected to accommodate different resonant modes of different structures of the body.

6. The apparatus of claim 1 wherein the actuator includes at least one cam having a non circular profile and rotating to produce non-sinusoidal cam displacement.

7. The apparatus of claim 1 wherein the platform includes cam followers resting against multiple synchronously driven and phased cams.

8. The apparatus of claim 7 the cam followers are compliant to control the acceleration on the platform.

9. The apparatus of claim 1 further including a speed controllable motor for an adjustment means for changing the time between the periodic accelerations.

10. The apparatus of claim 1 further including:
a seat pan for receiving a seated person resting their feet on a footplate; and
wherein the platform supports at least one of the seatpan and footplate.

11. An apparatus for mechanical stimulation of the body comprising:
a footplate for receiving feet of a person; and
an actuator attached to the footplate to impart a pattern of upward impulse accelerations on the footplate having greatest energy in at least two separate frequency bands differing in amplitude by no more than 20%.

12. The apparatus of claim 11 wherein the impulse acceleration are in the frequency range of 10 and about 100 Hz.

13. The apparatus of claim 11 further including an adjustment means for changing a time between accelerations and thus the frequency range of the accelerations.

14. The apparatus of claim 11 wherein the actuator produces a predetermined displacement of the footplate independent of a weight of the person.

15. The apparatus of claim 11 wherein the frequency bands of the accelerations are selected to accommodate different resonant modes of different structures of the body.

16. The apparatus of claim 11 wherein the actuator includes at least one cam having a non circular profile.

17. The apparatus of claim 11 wherein the footplate includes cam followers resting against multiple synchronously driven and phased cams.

18. The apparatus of claim 17 wherein the cam followers are compliant to limit the acceleration on the footplate.

19. The apparatus of claim 11 further including a speed controllable motor for an adjustment means for changing a time between the accelerations.

20. The apparatus of claim 11 further including:
a seat pan for receiving a seated person resting their feet on the footplate; and
a seat pan actuator attached to the seat pan to impart a pattern upward impulse accelerations on the seat pan having substantial energy in at least two separate frequency bands differing by no more than 20%.
